(19) United States
(12) Patent Application Publication
(10) Pub. No.: US 2005/0201462 A1
(43) Pub. Date: Sep. 15, 2005

(54) Method and device for motion estimation in scalable video editing

(75) Inventors: Justin Ridge, Sachse, TX (US); Yiliang Bao, Coppell, TX (US); Marta Karczewicz, Irving, TX (US)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/797,635

(22) Filed: Mar. 9, 2004

(51) Int. Cl. H04N 7/12

(52) U.S. Cl. 375/240.16; 375/240.12; 375/240.24

(57) ABSTRACT

A motion estimation procedure for bitrate scalability and spatial scalability, wherein an original video frame is divided into a plurality of rectangular blocks of coefficients and a plurality of reference blocks are formed from an offset of the rectangular blocks in both x and y directions. For a given original video frame, one or more reference frames are selected so that a plurality of differences between the reference blocks and the rectangular blocks can be computed partly based on the summation of the differences between individual coefficients in each block. A weighted sum of the differences is computed and minimized so as to optimize the offset.

### FIELD OF THE INVENTION

The present invention relates generally to the field of video coding and, more specifically, to scalable video coding.

### BACKGROUND OF THE INVENTION

Conventional video coding standards (e.g. MPEG-1, H.261/263/264) incorporate motion estimation and motion compensation to remove temporal redundancies between video frames. These concepts are very familiar to those with a basic understanding of video coding, and will not be described in detail here.

When motion estimation is performed at the encoder, a particular “reference frame” is searched in order to locate blocks that match a particular target block in the original. For the motion vectors generated using this process to be meaningful, the “reference frame” used for motion compensation in the decoder should be similar to the “reference frame” used in the encoder for motion estimation. When this is not so, the benefit of motion compensation diminishes, and the number of bits required to encode residual values increases, leading to an overall decrease in coding efficiency.

For scalable video coding, the number of possible reference frames is large—in addition to the normal temporal reference frames, it is also possible to use higher-layer quality or spatial references for motion estimation. Deciding which reference frame or frames to use in order to achieve satisfactory overall performance is a challenge.

One of the biggest problems associated with scalable video coding is that encoding all motion information in the base layer either causes base layer coding efficiency to drop dramatically, or penalizes quality at higher reconstruction layers. Effectively, efficiency at one layer is sacrificed to improve efficiency at another.

Many existing coders either encode a single set of motion vectors in the base layer, or a set of motion vectors in each enhancement layer.

### SUMMARY OF THE INVENTION

The present invention provides a method of motion estimation suitable for both bit-rate (or quality/SNR) scalability and spatial scalability. The present invention improves conventional motion estimation schemes for use in scalable video coding (SVC) by selecting the appropriate number of motion layers to be transmitted on a frame-by-frame basis, by using “adaptive block splitting” to subdivide motion vectors in higher motion layers, and by performing, for a given layer, motion estimation using a weighted combination of reference frames in such a way that that the given layer can be either dependent or independent of previous motion layers.

Thus, the first aspect of the present invention provides a method for motion estimation in coding video data indicative of a video sequence including a plurality of video frames, each frame containing a plurality of coefficients at different locations of the frame, said method comprising:

selecting at least one reference frame for a given original video frame;

partitioning said original video frame into rectangular blocks of coefficients;

forming at least one reference block of coefficients from an offset of the rectangular blocks;

computing the differences between said at least one reference block and the rectangular blocks; and

optimizing the offset.

According to the present invention, said selecting comprises:

obtaining M video frames for providing M references frames, wherein M is a positive integer greater than or equal to one.

According to the present invention, said forming comprises:

for each of said rectangular blocks of coefficients and each permutation of a horizontal offset value X and a vertical offset value Y, obtaining M additional rectangular blocks of coefficients for providing M reference blocks, wherein each of said M reference blocks of coefficients is formed by selecting coefficients from the M reference frames, such that the coefficients in the M reference blocks of coefficients are horizontally offset by distance X and vertically offset by distance Y from a corresponding coefficient in said rectangular block of coefficients.

According to the present invention, said computing comprises:

for each of said M reference blocks, obtaining the difference between said rectangular block and each said reference block of coefficients for providing a block difference at least partially involving summation of the differences between corresponding individual coefficients in each block.

According to the present invention, said optimizing comprises:

for each of said rectangular blocks of coefficients, determining an optimal horizontal offset X and vertical offset Y, wherein said determining is based at least partially on minimizing a weighted sum of M block differences.

According to the present invention, each of the M video frames selected as the M reference frames is computed based on the same frame of original video.

According to the present invention, the block differences for the M reference blocks are combined for providing a weighted sum having a plurality of weighting factors, and each weighting factor in the weighted sum is determined at least partially based upon a quantizer parameter or the index of the reference frame subjected to that weight.

According to the present invention, each of the M video frames selected as the M reference frames is computed by decoding the same frame of original video at a variety of quality settings.

According to the present invention, motion is represented by a motion vector to be encoded in bits, and wherein said determining is also based on the number of bits needed to encode the motion vector.

According to the present invention, the set of M reference frames is divided into N sub-sets, such that each of the M reference frames belongs to precisely one of the N sub-sets, and the process of determining the optimal horizontal offset X and vertical offset Y is repeated for each of said N sub-sets of reference frames, for indicating a set of N optimal horizontal offsets X and N vertical offsets Y. The number N may vary from one frame of video to another frame of video. The number N may vary from one frame of video to another frame of video, and the determination of the number N involves analysis of block differences in the previous frame.

According to the present invention, said determining of the optimal horizontal offset X and optimal vertical offset Y involves a discrimination against offsets with large magnitudes. The discrimination is at least partially dependent upon an index corresponding to which of the M reference frames is being considered.

Alternatively, for each rectangular block, the set of M reference blocks is divided into N sub-sets, such that each of the M reference blocks belongs to precisely one of the N sub-sets, and wherein the process of determining the optimal horizontal offset X and vertical offset Y is repeated for each of said N sub-sets of reference blocks, for indicating a set of N optimal horizontal offsets X and N vertical offsets Y. The number N of sub-sets may vary from one block to another within the given frame of video, said variation either based upon explicit signaling in the encoded bit stream or upon a deterministic algorithm and the size of a rectangular block in one of the N sub-sets is computed at least partially using the size of a rectangular block in another of the N sub-sets or the values of the horizontal offsets X and vertical offsets Y.

The second aspect of the present invention provides a coding device for coding video data indicative of a video sequence including a plurality of video frames, each frame containing a plurality of coefficients at different locations of the frame, said device comprising:

a motion estimation module, responsive to an input signal indicative of an original frame in the video sequence, for providing a set of predictions so as to allow a prediction module to form a predicted image; and

a combining module, responsive to the input signal and the predicted image, for providing residuals for encoding, wherein the motion estimation block comprises a mechanism for carrying out the steps of:

selecting at least one reference frame for a given original video frame;

partitioning said original video frame into rectangular blocks of coefficients;

forming at least one reference block of coefficients from an offset of the rectangular blocks;

computing the differences between said at least one reference block and the rectangular blocks; and

optimizing the offset.

The third aspect of the present invention provides a software program for use in motion estimation in coding video data indicative of a video sequence including a plurality of video frames, each frame containing a plurality of coefficients at different locations of the frame, said software program comprising:

a code for selecting at least one reference frame for a given original video frame;

a code for partitioning said original video frame into rectangular blocks of coefficients;

a code for forming at least one reference block of coefficients from an offset of the rectangular blocks;

a code for computing the differences between said at least one reference block and the rectangular blocks; and

a code for optimizing the offset.

According to the present invention, the code for selecting said at least one reference frame comprises:

a code for obtaining M video frames for providing M references frames, wherein M is a positive integer greater than or equal to one.

According to the present invention, the code for forming said at least one reference block comprises:

a code for obtaining M additional rectangular blocks of coefficients for providing M reference blocks, for each of said rectangular blocks of coefficients and each permutation of a horizontal offset value X and a vertical offset value Y, wherein each of said M reference blocks of coefficients is formed by selecting coefficients from the M reference frames, such that the coefficients in the M reference blocks of coefficients are horizontally offset by distance X and vertically offset by distance Y from a corresponding coefficient in said rectangular block of coefficients.

According to the present invention, the code for computing the differences comprises:

a code for obtaining, for each of said M reference blocks, the difference between said rectangular block and each said reference block of coefficients for providing a block difference at least partially involving summation of the differences between corresponding individual coefficients in each block.

According to the present invention, the code for optimizing the offset comprises:

a code for determining, for each of said rectangular blocks of coefficients, an optimal horizontal offset X and vertical offset Y, wherein the determination is based at least partially on minimizing a weighted sum of M block differences.

According to the present invention, the software program further comprises:

a code for combining the block differences for the M reference blocks for providing a weighted sum having a plurality of weighting factors, wherein each weighting factor in the weighted sum is determined at least partially based upon a quantizer parameter or the index of the reference frame subjected to that weight.

According to the present invention, the set of M reference frames is divided into N non-overlapping subsets, and the code for determining the optimal horizontal offset X and vertical offset Y repeats the process for each of said N sub-sets of reference frames, for indicating a set of N optimal horizontal offsets X and N vertical offsets Y.

According to the present invention, for each rectangular block, the set of M reference blocks is divided into N non-overlapping sub-sets, and the code for determining the optimal horizontal offset X and vertical offset Y repeats the process for each of said N sub-sets of reference blocks, for indicating a set of N optimal horizontal offsets X and N vertical offsets Y.

The present invention will become apparent upon reading the description taken in conjunction with FIGS. 1-3.

### BRIEF DESCRIPTION OF THE DRAWINGS

FIG. 1 is a flowchart illustrating the method for motion estimation, according to the present invention.

FIG. 2 is a block diagram illustrating a video encoder having a motion estimation module, according to the present invention.

FIG. 3 is a block diagram illustrating a video decoder, which can be used to reconstruct video from video data provided by the video encoder, according to the present invention.

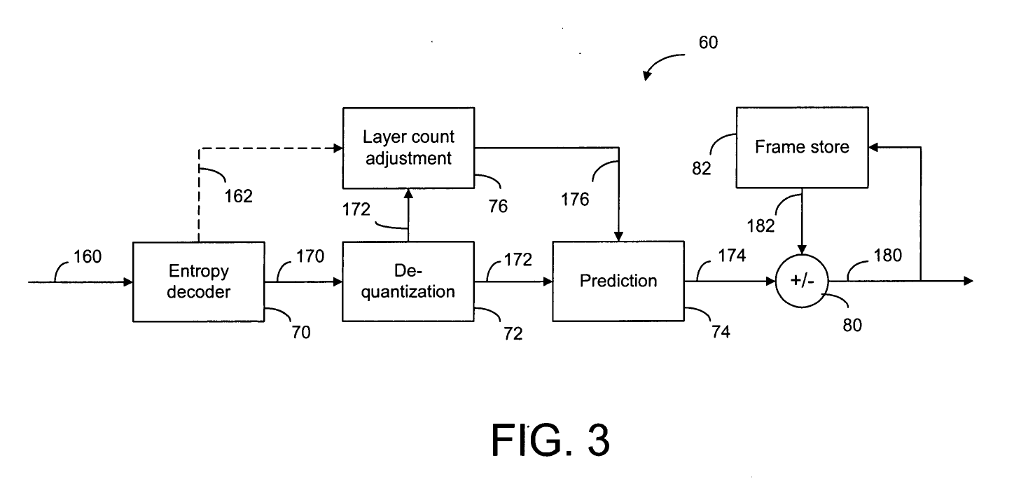

### DETAILED DESCRIPTION OF THE INVENTION

It is known that when motion estimation is performed at the encoder, a particular “reference frame” is searched in order to locate blocks that match a particular target block in the original. For the motion vectors generated using this process to be meaningful, the “reference frame” used for motion compensation in the decoder should be similar to the “reference frame” used in the encoder for motion estimation. The “reference frames” in this context may be generated from the same frame of original video. For example, the reference frames may arise from reconstruction at different qualities or spatial resolutions. Thus, in conventional video coding, “multiple reference frames” exist with time as the only variable (i.e. only along one axis of scalability), whereas for the present invention, the reference frames exist along all three axes (time, quality, and spatial). The present invention allows for an improvement in average coding efficiency, i.e. rather than a noticeably poor performance in a particular spatial or quality layer, the coding efficiency is more balanced.

As previously mentioned, the present invention provides three novel approaches in motion estimation:

1. selecting, on a frame-by-frame basis, an appropriate number of motion layers to be transmitted;

2. using adaptive block splitting to subdivide motion vectors in higher motion layers; and

3. performing, for a given motion layer, motion estimation using a weighted combination of reference frames.

Multiple References

Let us consider the case where all motion information is sent in the base layer.

Using the base layer reconstruction as the reference frame for motion estimation would lead to a highly tuned (i.e. very efficient) base layer, but those motion vectors may lack the precision required for good performance at higher layers, and consequently upper layer coding efficiency is likely to be poor.

Conversely, using an upper layer (i.e. high quality) reconstruction as the reference frame for motion estimation would lead to efficient performance at the upper layer, but the number of motion bits encoded in the base layer to achieve this efficiency would severely degrade performance if only the base layer is transmitted or decoded.

In order to avoid these disadvantages, the present invention uses a combination of available reference frames in the motion estimation process.

Conventionally, in a conventional encoder the distance between two blocks is expressed in terms of “the sum of absolute difference” (SAD), given by

$$SAD = λ ( B ( x ) + B ( y ) ) + {\sum }_{i} \vert {c}_{i} - {r}_{i} \vert$$

where λ is a Lagrangian multiplier based upon the quantizer parameter (QP); B(x) and B(y) are the number of bits needed to encode the x and y components of the candidate motion vector, respectively; cᵢ is the value of the i th coefficient from the current original frame, and rᵢ is the value of the i th coefficient from the block in the reference frame being compared against.

In the present invention, a weighted combination of reference frames is used. Thus, the distance between two blocks is given by:

$$SAD = λ ( B ( x ) + B ( y ) ) + {\sum }_{n} {w}_{n} {\sum }_{i} \vert {c}_{i} - {r}_{n , i} \vert$$

where r_{n,i} is the i th coefficient from the block being compared against in the n th reference frame, and wₙ is a weighting factor specific to the reference frame under consideration.

In a three-layer system, if the vector of weights is set to W=[1,0,0] then it is equivalent to using only the base layer reconstruction as the reference frame; similarly if W=[0,0,1] it is equivalent to using only the highest layer reconstruction as the reference frame.

The advantage of the present invention over the prior art is apparent when the weightings are fractional, and even more so when they are computed dynamically, i.e. wₙ=F(n, . . . ) where the function F may take as inputs relatively static parameters (e.g. the target bit-rate) along with dynamic parameters (e.g. the residual energy from the previous frame). To illustrate, when spatially scalable motion is desired, it often makes sense to switch from using a weighting such as [0,0.5,1] at high bit-rates to [1,0.5,0] at lower bit-rates. In this case,

$$F ( n , QP ) = \{ \begin{matrix}1 , & ( n = 0 and QP > K ) or ( n = 2 and QP < K ) \\ 0.5 , & n = 1 \\ 0 , & otherwise\end{matrix}$$

To summarize, the core concept described thus far is that a weighted sum of reference frame differences is used to compute the SAD, where the weighting matrix may be either static, or computed dynamically by a mathematical function that takes as inputs coding parameters and/or encoder state properties.

With the use of multiple references, other respects of the motion estimation process, such as partial pel motion refinement and block size selection, can be carried out in a conventional way.

Multiple Motion Layers

It is possible to further improve the coding efficiency in some cases by encoding multiple motion layers. To illustrate how multiple motion layer encoding is carried out, the set of reference frames is categorized as “belonging” to one or another motion layer, and the “weighted SAD” calculation previously described can be used without further change. That is, for motion layer m, we have

$${SAD}_{m} = λ ( B ( x ) + B ( y ) ) + {\sum }_{n ∈ M} {w}_{n} {\sum }_{i} \vert {c}_{i} - {r}_{n , i} \vert$$

where M denotes the set of reference frame indices that are assigned to motion layer m.

When there are multiple motion layers, the decision regarding whether a motion vector should be sent in one or another layer may be determined by computing the Lagrangian parameter dynamically, i.e. λₙ=G(n, . . . ), where G takes similar inputs to function F described previously.

In a further variation, the “predicted motion vector” used as a starting point for motion estimation in the second and higher motion layers may be determined in part based upon the corresponding motion vector in a lower motion layer.

Automatic or Dynamic Layer Count Modification

The extension to the basic scheme enabling multiple motion layers has been described in the previous section. In that approach, it is assumed that the number of motion layers is fixed for a given coder design. A further extension involves computing the ideal number of motion layers automatically, or varying it dynamically.

The further extension starts out with an arbitrary number of motion layers and either adds or drops motion layers as necessary on a per-frame basis. The determination to add a motion layer is made by considering the variance trend of the outer sum in the SAD computation. Mathematically, the motion layer m can be expressed as follows:

$$\begin{matrix}{SAD}_{m} = λ ( B ( x ) + B ( y ) ) + {\sum }_{n ∈ M} {w}_{n} {\sum }_{i} \vert {c}_{i} - {r}_{n , i} \vert \\ = λ ( B ( x ) + B ( y ) ) + {\sum }_{n ∈ M} {w}_{n} {d}_{n}\end{matrix}$$

From each block the values of dₙ for layer m are collected and the variance is computed, i.e. σₙ²=var(Dₙ). Here dₙ is the sum of absolute differences between the original coefficients and the corresponding coefficients from the block being compared against in the reference frame. Because dₙ is calculated for a given block, dₙ can be written as d1ₙ, d2ₙ, d3ₙ, if 3 blocks of coefficients are used for comparison, for example. In that case, Dₙ is the set for dxₙ, with x=1,2,3, or Dₙ={d1ₙ,d2ₙ, d3ₙ}.

If the variance shows a trend of increasing with reference index (e.g. the variance corresponding to the highest reference index is greater than the variance corresponding to the lowest reference index by some ratio or some threshold), then it can be determined that the upper reference index should be moved into a new motion layer.

Conversely, if the variance trend across motion layer boundaries is found to be flat, the two motion layers may be consolidated.

So far the splitting and merging of motion layers from the perspective of the encoder has been disclosed. However, it is also possible that the decoder could choose to add or drop a motion layer, e.g. in response to changing channel capacity. A potential problem with dropping layers could arise if those layers are interdependent. One solution to this is to send a “MI-layer” or motion-independent layer where there are no dependencies between motion layers. While a similar end could be achieved with an I-frame, the MI-layer is intended to be a more rate-efficient method to facilitate dropping of layers.

Adaptive block splitting

A special case of motion layering is block splitting. This is where a block covered by a single motion vector is decomposed into a series of smaller blocks at a higher SNR or spatial layer, each with an individual motion vector. For example, an 8×8 block in the base layer may be divided into four 4×4 blocks, so that the number of motion vectors increases from one to four.

To determine whether block splitting should be utilized, the cost in bits of transmitting the four motion vectors, relative to the improvement in SAD, is measured. A standard Lagrangian equation can be used to compute the SAD with four motion vectors:

$${SAD4}_{m} = {\sum }_{k = 1 … 4} {λ}_{k} ( B ( {x}_{k} ) + B ( {y}_{k} ) ) + {\sum }_{n ∈ M} {w}_{n} {d}_{n}$$

The resulting value is then compared against the SAD computed without the block splitting, and if it is smaller, then block splitting should proceed.

Finally, the motion vector that is used for refinement is determined based on the variance of the four motion vectors transmitted. If the vector of the larger block (in the lower motion layer) is large compared to the average motion vector of the other four, then the motion vector prediction is based upon spatial neighbors in the current motion layer. However, if the vector of the larger block is smaller, it is selected for the predicted motion vector.

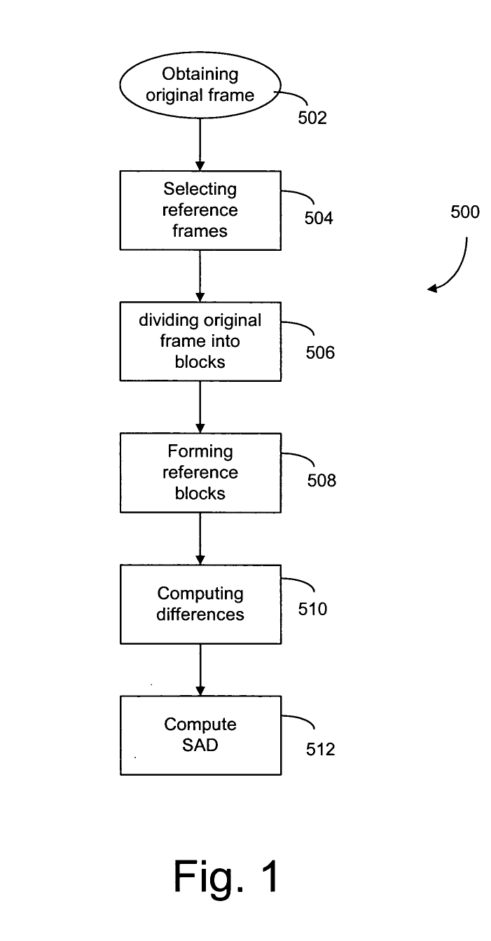

FIG. 1 is a flowchart illustrating the video coding, according to the present invention, where motion estimation is carried out with reference frames for a given original video frame. As shown, the flowchart 500 starts at step 502 where an original video frame is obtained. At step 504, M reference frames are selected for the given original frame. Each of the M reference frames can be computed by decoding the same frame of the original video at a variety of quality settings. At step 506, the original video frame is partitioned into a plurality of rectangular blocks of coefficients. At step 508, for each of the rectangular blocks of coefficients and each offset, there is an additional forming of M reference blocks of coefficients. The offset is a permutation of a horizontal offset value (x) and a vertical offset value (y). At step 510, for each of the M reference blocks, the difference is computed between the rectangular block and the reference block of coefficients for providing a block difference, at least partially involving summation of the difference between individual coefficients in each block. At block 512, for each rectangular block of coefficients, and optimal offset is determined, at least partially based on minimizing a weighted sum of M block differences. The weighting factors used in the weighted sum are determined at least partially based on the quantizer parameter or the index of the reference frame subjected to that weight. Furthermore, the set of M reference frames can be divided into N subsets such that each of the M reference frames belongs to precisely one of the N subsets. As such, the optimal offset is repeated for each of the N subsets of reference frames. The optimal offset is computed in a process involving a discrimination against offsets with large magnitudes. N may vary from one frame to another, based on the block differences in the previous frame. Alternatively, for each rectangular block, the set of M reference blocks is divided into non-overlapping N subsets for determining the optimal offset.

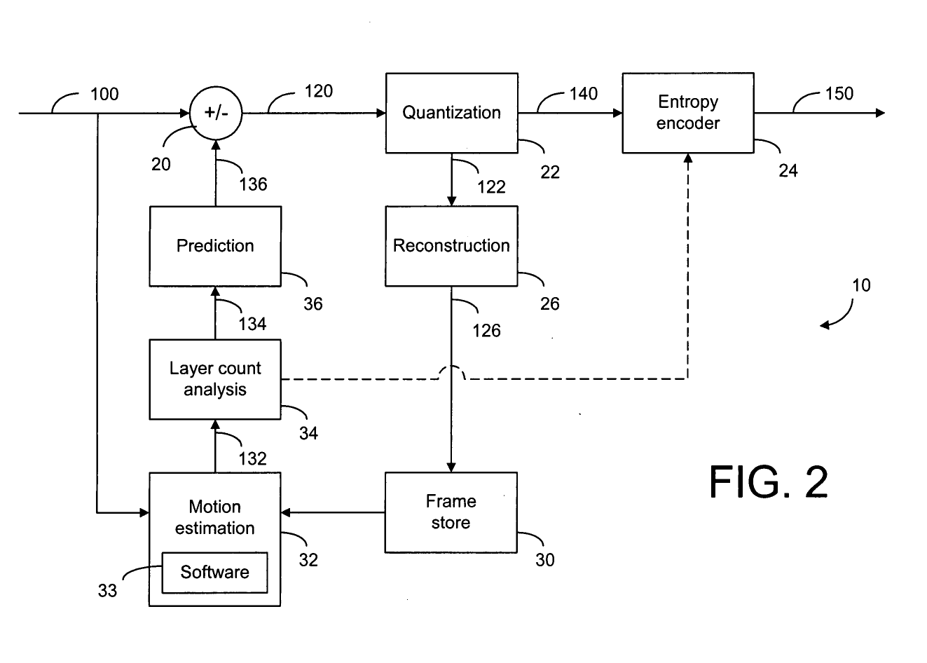

FIG. 2 is a block diagram illustrating a video encoder in which the motion estimation method, according to the present invention, can be implemented. As shown in FIG. 1, the encoder 10 receives input signals 100 indicative of an original frame, and provides signals 150 indicative of encoded video data to a transmission channel (not shown). The encoder 10 comprises a motion estimation block 32 to carry out motion estimation across multiple layers and generates a set of predictions, using the method of the present invention. The layer count analysis block 34, based on the signals 132 indicative of the set of predictions, adjusts the number of layers. The resulting motion data 134 is passed to the motion compensation or prediction block 36. The prediction block 36 forms predicted image 136. As the predicted image 136 is subtracted original frame by a combining module 20, the residuals 120 is provided to a quantiation block 22, which performs quantization to reduce magnitude and sends the quantized data 140 to the reconstruction block 26 and the entropy coder 24. After reconstructed by the reconstruction block 26, the residuals are sent to a frame store 30, where reference frames are provided to the motion estimation block 32 for motion estimation. The entropy encoder 24 encodes the residuals into encoded video data 150.

It should noted that, various blocks, such as the motion estimation block 32, the layer count analysis block 34, and the quantization block 22, in the encoder 10 may have a software program to carry out their respective functions. For example, the motion estimation block 32 may have a software program 33 to carry out the various steps in motion estimation, according to the present invention.

In the receive side, an decoder 60 uses an entropy decoder 70 to decode video data 160 from the transmission channel into decoded quantized data 170. A de-quantization block 72 converts the quantized data into residuals 172 so as to allow the prediction block 74 to form predicted images 174, with the aid of motion information 176 provided by the layer count adjustment block 76. With the reference frame 182 from the frame store 82 and the predicted image 174, a combination module 80 provides signals 180 indicative of reconstructed video image.

Although the invention has been described with respect to one or more embodiments thereof, it will be understood by those skilled in the art that the foregoing and various other changes, omissions and deviations in the form and detail thereof may be made without departing from the scope of this invention.

1. A method for motion estimation in coding video data indicative of a video sequence including a plurality of video frames, each frame containing a plurality of coefficients at different locations of the frame, said method comprising:
selecting at least one reference frame for a given original video frame;
partitioning said original video frame into rectangular blocks of coefficients;
forming at least one reference block of coefficients from an offset of the rectangular blocks;
computing the differences between said at least one reference block and the rectangular blocks; and
optimizing the offset.

2. The method of claim 1, wherein said selecting comprises:
obtaining M video frames for providing M references frames, wherein M is a positive integer greater than or equal to one.

3. The method of claim 2, wherein said forming comprises:
for each of said rectangular blocks of coefficients and each permutation of a horizontal offset value X and a vertical offset value Y, obtaining M additional rectangular blocks of coefficients for providing M reference blocks, wherein each of said M reference blocks of coefficients is formed by selecting coefficients from the M reference frames, such that the coefficients in the M reference blocks of coefficients are horizontally offset by distance X and vertically offset by distance Y from a corresponding coefficient in said rectangular block of coefficients.

4. The method of claim 3, wherein said computing comprises:
for each of said M reference blocks, obtaining the difference between said rectangular block and each said reference block of coefficients for providing a block difference at least partially involving summation of the differences between corresponding individual coefficients in each block.

5. The method of claim 4, wherein said optimizing comprises:
for each of said rectangular blocks of coefficients, determining an optimal horizontal offset X and vertical offset Y, wherein said determining is based at least partially on minimizing a weighted sum of M block differences.

6. The method of claim 2, wherein each of the M video frames selected as the M reference frames is computed based on the same frame of original video.

7. The method of claim 4, wherein the block differences for the M reference blocks are combined for providing a weighted sum having a plurality of weighting factors, and wherein each weighting factor in the weighted sum is determined at least partially based upon a quantizer parameter or the index of the reference frame subjected to that weight.

8. The method of claim 2, wherein each of the M video frames selected as the M reference frames is computed by decoding the same frame of original video at a variety of quality settings.

9. The method of claim 5, wherein motion is represented by a motion vector to be encoded in bits, and wherein said determining is also based on the number of bits needed to encode the motion vector.

10. The method of claim 5, wherein the set of M reference frames is divided into N sub-sets, such that each of the M reference frames belongs to precisely one of the N sub-sets, and wherein the process of determining the optimal horizontal offset X and vertical offset Y is repeated for each of said N sub-sets of reference frames, for indicating a set of N optimal horizontal offsets X and N vertical offsets Y.

11. The method of claim 5, wherein said determining of the optimal horizontal offset X and optimal vertical offset Y involves a discrimination against offsets with large magnitudes.

12. The method of claim 11, wherein the discrimination is at least partially dependent upon an index corresponding to which of the M reference frames is being considered.

13. The method of claim 10, where the number N may vary from one frame of video to another frame of video.

14. The method of claim 11, where the number N may vary from one frame of video to another frame of video, and the determination of the number N involves analysis of block differences in the previous frame.

15. The method of claim 3, wherein for each rectangular block, the set of M reference blocks is divided into N sub-sets, such that each of the M reference blocks belongs to precisely one of the N sub-sets, and wherein the process of determining the optimal horizontal offset X and vertical offset Y is repeated for each of said N sub-sets of reference blocks, for indicating a set of N optimal horizontal offsets X and N vertical offsets Y.

16. The method of claim 15, wherein the number N of sub-sets may vary from one block to another within the given frame of video, said variation either based upon explicit signaling in the encoded bit stream or upon a deterministic algorithm.

17. The method of claim 16, wherein the size of a rectangular block in one of the N sub-sets is computed at least partially using the size of a rectangular block in another of the N sub-sets or the values of the horizontal offsets X and vertical offsets Y.

18. A coding device for coding video data indicative of a video sequence including a plurality of video frames, each frame containing a plurality of coefficients at different locations of the frame, said device comprising:
a motion estimation module, responsive to an input signal indicative of an original frame in the video sequence, for providing a set of predictions so as to allow a prediction module to form a predicted image; and
a combining module, responsive to the input signal and the predicted image, for providing residuals for encoding, wherein the motion estimation block comprises a mechanism for carrying out the steps of:
selecting at least one reference frame for a given original video frame;
partitioning said original video frame into rectangular blocks of coefficients;
forming at least one reference block of coefficients from an offset of the rectangular blocks;
computing the differences between said at least one reference block and the rectangular blocks; and
optimizing the offset.

19. The device of claim 18, wherein the step of selecting comprises the step of:
obtaining M video frames for providing M references frames, wherein M is a positive integer greater than or equal to one.

20. The device of claim 19, wherein the step of forming comprises the step of:
obtaining M additional rectangular blocks of coefficients for providing M reference blocks, for each of said rectangular blocks of coefficients and each permutation of a horizontal offset value X and a vertical offset value Y, wherein each of said M reference blocks of coefficients is formed by selecting coefficients from the M reference frames, such that the coefficients in the M reference blocks of coefficients are horizontally offset by distance X and vertically offset by distance Y from a corresponding coefficient in said rectangular block of coefficients.

21. The device of claim 20, wherein the step of computing comprises the step of:
obtaining, for each of said M reference blocks, the difference between said rectangular block and each said reference block of coefficients for providing a block difference at least partially involving summation of the differences between corresponding individual coefficients in each block.

22. The device of claim 21, wherein the step of optimizing comprises the step of:
determining, for each of said rectangular blocks of coefficients, an optimal horizontal offset X and vertical offset Y, wherein said determining is based at least partially on minimizing a weighted sum of M block differences.

23. A software program for use in motion estimation in coding video data indicative of a video sequence including a plurality of video frames, each frame containing a plurality of coefficients at different locations of the frame, said software program comprising:
a code for selecting at least one reference frame for a given original video frame;
a code for partitioning said original video frame into rectangular blocks of coefficients;
a code for forming at least one reference block of coefficients from an offset of the rectangular blocks;
a code for computing the differences between said at least one reference block and the rectangular blocks; and
a code for optimizing the offset.

24. The software program of claim 23, wherein the code for selecting said at least one reference frame comprises:
a code for obtaining M video frames for providing M references frames, wherein M is a positive integer greater than or equal to one.

25. The software program of claim 24, wherein the code for forming said at least one reference block comprises:
a code for obtaining M additional rectangular blocks of coefficients for providing M reference blocks, for each of said rectangular blocks of coefficients and each permutation of a horizontal offset value X and a vertical offset value Y, wherein each of said M reference blocks of coefficients is formed by selecting coefficients from the M reference frames, such that the coefficients in the M reference blocks of coefficients are horizontally offset by distance X and vertically offset by distance Y from a corresponding coefficient in said rectangular block of coefficients.

26. The software program of claim 25, wherein the code for computing the differences comprises:
a code for obtaining, for each of said M reference blocks, the difference between said rectangular block and each said reference block of coefficients for providing a block difference at least partially involving summation of the differences between corresponding individual coefficients in each block.

27. The software program of claim 26, wherein the code for optimizing the offset comprises:
a code for determining, for each of said rectangular blocks of coefficients, an optimal horizontal offset X and vertical offset Y, wherein the determination is based at least partially on minimizing a weighted sum of M block differences.

28. The software program of claim 26, further comprising
a code for combining the block differences for the M reference blocks for providing a weighted sum having a plurality of weighting factors, wherein each weighting factor in the weighted sum is determined at least partially based upon a quantizer parameter or the index of the reference frame subjected to that weight.

29. The software program of claim 27, wherein the set of M reference frames is divided into N non-overlapping subsets, and wherein the code for determining the optimal horizontal offset X and vertical offset Y repeats the process for each of said N sub-sets of reference frames, for indicating a set of N optimal horizontal offsets X and N vertical offsets Y.

30. The software program of claim 25, wherein for each rectangular block, the set of M reference blocks is divided into N non-overlapping sub-sets, and wherein the code for determining the optimal horizontal offset X and vertical offset Y repeats the process for each of said N sub-sets of reference blocks, for indicating a set of N optimal horizontal offsets X and N vertical offsets Y.
